(19) United States
(12) Patent Application Publication
(10) Pub. No.: US 2026/0082263 A1
(43) Pub. Date: Mar. 19, 2026

(54) Methods and Systems for Modifying Cellular Communications to Accommodate Radio Frequency Identification (RFID) Communications

(71) Applicant: T-Mobile Innovations LLC, Overland Park, KS (US)

(72) Inventor: Lyle PACZKOWSKI, Mission Hills, KS (US)

(21) Appl. No.: 18/886,936

(22) Filed: Sep. 16, 2024

(51) Int. Cl. H04W 28/02; H04W 4/80

(52) U.S. Cl. CPC H04W 28/02; H04W 4/80

(57) ABSTRACT

A core network is configured to receive a first message indicative of a trigger event at a mobile device, in which the trigger event occurs when the mobile device is initiating an RFID communication with an RFID tag over a frequency channel, in which the mobile device is also configured to communicate with a cell site associated with the core network over the frequency channel, and perform an interference mitigation action on a cellular communication destined for the mobile device over the frequency channel, in which the interference mitigation action comprises temporarily caching the cellular communication destined for the mobile device over the frequency channel or rerouting the cellular communication destined for the mobile device over another frequency channel.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Radio frequency identification (RFID) communications are used to interact with RFID tags over short distances, sometimes within a few centimeters to several meters, using specific predefined frequency ranges. Cellular radio communications, on the other hand, enable long-range communication between mobile devices and cell sites, operating in licensed frequency bands designated for cellular networks. RFID and cellular communications differ significantly in range, power, and application. RFID systems are designed for inventory tracking, access control, and asset management, while cellular networks support voice calls, text messaging, and internet connectivity.

### SUMMARY

In an embodiment, a method for modifying a cellular connection with a cell site to accommodate a radio frequency identification (RFID) connection with one or more tags is disclosed. The method comprises determining, by an application at a mobile device, that the mobile device has entered a location with the one or more tags, in which the mobile device is configured to communicate with the one or more tags over a frequency channel and the mobile device is configured to communicate with a cell site associated with a core network over the frequency channel. The method further comprises detecting, by the application, a trigger event at the mobile device indicating that the mobile device is initiating an RFID communication with a tag of the one or more tags over the frequency channel, transmitting, by the application to a core application at the core network, a message indicating that the mobile device has initiated the RFID communication over the frequency channel, and modifying, by the core application, cellular configurations of the cell site to reroute first cellular communications destined for the mobile device during a predefined period of time over another frequency channel in response to receiving the message. The method further comprises transmitting, by the application, an interrogation signal over the frequency channel to activate the tag, receiving, by the application, a response from the tag, extracting, by the application, data from the response received from the tag, storing, by the application, the data locally in a memory of the mobile device, and resetting, by the core application, a cellular configuration of the cell site to reroute second cellular communications destined for the mobile device over the frequency channel after receiving the response.

In another embodiment, a method for modifying a cellular connection with a cell site to accommodate a radio frequency identification (RFID) connection with an RFID tag is disclosed. The method comprises detecting, by an application at a mobile device, a trigger event at the mobile device indicating that the mobile device is initiating an RFID communication with the RFID tag over a frequency channel, in which the mobile device is also configured to communicate with a cell site associated with a core network over the frequency channel. The method further comprises transmitting, by the application to a core application at a core network system, a first message indicating that the mobile device has initiated the RFID communication over the frequency channel, and receiving, by the application, a first indication that the core application is performing an interference mitigation action on cellular communications destined for the mobile device over the frequency channel, in which the interference mitigation action comprises at least one of temporarily caching the cellular communications destined for the mobile device over the frequency channel or rerouting the cellular communications destined for the mobile device over another frequency channel. The method further comprises transmitting, by the application, an interrogation signal over the frequency channel to activate the RFID tag in response to receiving the first indication, receiving, by the application, a response from the RFID tag, transmitting, by the application to the core application, a second message indicating that the RFID communication between the mobile device and the RFID tag is complete after receiving the response from the RFID tag, and receiving, by the core application, a second indication that the core application has reset the cellular communications destined for the mobile device to be communicated over the frequency channel.

In yet another embodiment, a core network system. The core network system comprises a memory, a processor, and a core application comprising instruction stored on the memory. The core application, when executed by the processor, causes the processor to receive, by a core application at a core network, a first message indicative of a trigger event at a mobile device, in which the trigger event occurs when the mobile device is initiating an RFID communication with an RFID tag over a frequency channel, in which the mobile device is also configured to communicate with a cell site associated with the core network over the frequency channel, perform an interference mitigation action on a cellular communication destined for the mobile device over the frequency channel, in which the interference mitigation action comprises temporarily caching the cellular communication destined for the mobile device over the frequency channel or rerouting the cellular communication destined for the mobile device over another frequency channel, receive a second message indicating that the RFID communication between the mobile device and the RFID tag is complete, terminate the interference mitigation action on the cellular communication destined for the mobile device over the frequency channel, and reset a cellular configuration of the cell site to reroute second cellular communications destined for the mobile device over the frequency channel.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network according to various embodiments of the disclosure.

FIG. 2 is a diagram illustrating a mobile device, core network, and cell site performing cellular communications and RFID communications in the communication network of FIG. 1 according to various embodiments of the disclosure.

FIG. 3 is a message sequence diagram illustrating a first method for modifying cellular communications to accommodate RFID communications in the communication system of FIG. 1 according to various embodiments of the disclosure.

FIG. 4 message sequence diagram illustrating a second method for modifying cellular communications to accommodate RFID communications in the communication system of FIG. 1 according to various embodiments of the disclosure.

FIG. 5 is message sequence diagram illustrating a third method for modifying cellular communications to accommodate RFID communications in the communication system of FIG. 1 according to various embodiments of the disclosure

FIG. 6 is a flowchart illustrating a first method of modifying cellular communications to accommodate RFID communications according to various embodiments of the disclosure.

FIG. 7 is a flowchart illustrating a second method of modifying cellular communications to accommodate RFID communications according to various embodiments of the disclosure

FIG. 8 is a block diagram of a computer system implemented within the communication system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

RFID communications and cellular radio communications are different types of communications, each using different frequency ranges, fulfilling different purposes, and offering different advantages over the other. For example, RFID systems may use passive tags that do not have their own power source, relying instead on the electromagnetic energy transmitted through radio frequency signals to power the tag and send back data. In contrast, cellular communications involve active devices, such as smartphones, which have their own power sources (batteries) and can transmit data over long distances to cell sites. Additionally, RFID systems are optimized for rapid, localized data collection and identification, whereas cellular networks are built to maintain continuous, high-quality connections across varying distances and conditions. Therefore, while RFID communications are specialized for short-range, low-power interactions with passive tags for applications like inventory tracking, cellular communications are designed for long-range, high-speed connectivity between active devices and cell towers, supporting a wide range of mobile communication services.

Despite these differences, both RFID communications and cellular radio communications rely on antennas and radio transceivers to send and receive data wirelessly. Both technologies use antennas and radio transceivers (devices that can both transmit and receive signals) to handle communication. In cellular systems, both the cell phone and the cell sites have radio transceivers to maintain two-way communication, while RFID systems use a combination of antennas, radio transceivers, and reader devices to maintain communication with RFID tags.

However, the radio transceivers used in RFID communications operate in frequency bands designed for RFID communications, while the radio transceivers used for cellular radio communications operate in frequency bands optimized for cellular communications. RFID frequency bands refer to predefined frequency bands, channels, or ranges dedicated for RFID communications. For example, RFID frequency bands may include low frequency bands ranging between 125 kHz to 134 kHz, high frequency bands at 13.56 MHz, ultra-high frequency bands ranging between 860 MHz to 960 MHz, and microwave frequency bands at 2.4 GHz and above. Meanwhile, cellular frequency bands refer to predefined frequency bands, channels, or ranges dedicated for cellular communications. For example, cellular frequency bands may include low frequency bands at 600 MHz, 700 MHz, or 800 MHz, mid-frequency bands at 1.8 GHz or 2.1 GHz, or high frequency bands at 3.5 GHz, 5GHz, or 47 GHz. To this end, RFID reader devices may be equipped with antennas/reader devices/radio transceivers operable to communicate at the RFID frequency bands, while cellular-based devices may be equipped with antennas/radio transceivers operable to communicate at the cellular frequency bands.

In some cases, the radio transceivers of the cellular devices (also referred to herein as “mobile devices”) that are used for cellular radio communications may also be used for RFID communications. The RFID communications may be performed over the cellular frequency bands, as opposed to the RFID frequency bands. The process of sending radio frequency signals to power the tags and obtain data back from the tags may be performed using radio frequency signals transmitted over the cellular frequency bands, again, as opposed to over the RFID frequency bands.

For example, a mobile phone may be enabled as both a cellular communications device and an RFID communications device in the same 800 MHz frequency channel The cell site may determine the 800 MHz frequency channel as the optimal frequency channel to use for communicating with the mobile device, while the mobile device may be preconfigured to perform RFID scans using the same 800 MHz frequency channel. The user may, for example, communicate over the frequency channel to read RFID tags on items in a retail store to purchase the items, perform inventory tracking or management, etc. The user may also communicate over the frequency channel to read RFID tags for purposes of access control. The user may also receive cellular data (e.g., services, voice calls, messages, etc.) from the cell site over the same frequency channel.

Therefore, when mobile devices communicate (e.g., send and receive radio communication signals) over common cellular frequency bands to perform both cellular communications and RFID communications, the mobile devices may experience interference and unwanted crosstalk between both types of communications. That is, the mobile device may not be able to scan an RFID tag and receive a cellular service at the same time over the same frequency channel. For example, a user may enter a retail store with the mobile device while the nearest cell site is configured to transmit cellular communications (e.g., calls, texts, messages, services, etc.) to the mobile device over a particular frequency channel. While in the retail store, the user may want to scan an RFID tag on an item in the retail store to receive more details on the item or purchase the item. The mobile device may be configured to read the RFID tag using the same frequency channel used by the cell site for cellular communications. In this case, when the device is in the process of reading the RFID tag on the frequency channel, the reading of the RFID tag may be interrupted if a call, text, file, or other cellular service is received from the cell site over the same frequency channel. Alternatively, the calls, texts, messages, and other cellular services sent to the mobile device on a particular frequency channel may be dropped or discarded altogether if the mobile device is reading an RFID tag over the same frequency channel at the same time. Therefore, enabling mobile devices to perform RFID and cellular communications over the same frequency bands may cause various technical problems, including dropped calls, messages, and services, and decreased network capacity resulting from the failed communications.

The present disclosure addresses the foregoing technical problems by providing a technical solution in the technical field of cellular and RFID communications, by modifying cellular communications between the cell site and the mobile phone to enable the mobile phone to perform RFID communications without interference. In various embodiments, a core network providing cellular communications and services to the mobile device via the cell site may perform one or more interference mitigation actions when the mobile device is performing an RFID communication. The interference mitigation action may prevent the mobile device from receiving cellular communications and services over the same frequency channel as the RFID communication. By preventing the mobile device from receiving cellular communications and RFID communications over the same frequency channel at the same time, the embodiments disclosed herein prevent failures in both RFID and cellular communications. Moreover, by preventing communication failures, the embodiments disclosed herein increase network capacity and increase the security of both the RFID and cellular communications.

In an embodiment, the mobile device may be connected to a cell site of a core network associated with a telecommunications service provider, and the user of the mobile device may be registered with the telecommunications service provider as a subscriber. The core network may maintain subscription information related to the user (e.g., identification information, subscription plans, purchased devices, billing information, etc.). The cell site determines the frequency band over which to communicate with different subscriber devices based on a combination of factors, including, for example, network configurations, device capabilities, current network conditions, and policy decisions. For example, a cell site serving a mobile device may determine a particular frequency channel (e.g., 800 MHz) for optimal communications with the mobile device. Meanwhile, the mobile device may be programmed to perform RFID communications over the same frequency channel. For example, the mobile device may use the radio transceiver and antenna combination, or a separate detachable attachable reader device, to propagate radio frequency signals over the frequency channel in the direction of an RFID tag to read data from the RFID tag.

When a mobile is enabled to perform cellular and RFID communications over the same frequency channel, a problem may arise when the user enters a location including one or more RFID tags. The location may be an inventory environment, such as, for example, a warehouse or retail store, in which items are coupled to RFID tags that may be used to identify the items. The location may also be a secure building, in which the RFID tags are used for access control within or to the building. An application executing at the mobile device may determine when the user enters a location with one or more RFID tags, for example, by detecting the presence of RFID tags within a predefined distance from the mobile device. In this case, the application may store data associated with the location at a data store of the mobile device, and transmit a message to a core application executing at the core network indicating that the mobile device has entered a location with one or more RFID tags.

The core application may then be made aware that the mobile device may, in the near future, perform RFID communications using one or more cellular frequency bands. The core application may perform various actions based on this awareness, such as, for example, monitoring tasks, actions, and a location of the mobile device as the mobile device enters the location, moves through the location, and exits the location. The core application may also at this stage be in a waiting phase, waiting for a message from the mobile device indicating the initiation of an RFID communication over a frequency channel.

When the user desires to read an RFID tag in the location, the user may open a reader application at the mobile device, which may operate with the reader device or radio transceiver at the mobile device to send an interrogation signal to the RFID tag. The interrogation signal may be radio frequency signals transmitted over a predefined frequency channel (e.g., a preset cellular frequency channel at the mobile device used for RFID communications). For example, the user may select an icon or button on the mobile device to begin transmitting the interrogation signal. The application at the mobile may detect a trigger event at the mobile device, either when the user opened the reader application or when the user selected the icon or button, in which the trigger event indicates that the mobile device is initiating an RFID communication with the RFID tag over the predefined frequency channel. In response to the trigger event, the application at the mobile device may transmit a message to the core application at the core network, in which the message includes trigger event data describing the trigger event and indicates that the mobile device has initiated the RFID communication over the predefined frequency channel.

In response to receiving this message, the core application may first determine whether the predefined frequency channel used for the RFID communication (e.g., indicated in the message) matches the frequency channel over which the cell site is currently configured to communicate with the mobile device (e.g., indicated in stored configurations at the core network). When the core application determines that these frequency channels indeed match, the core application may perform an interference mitigation action to prevent both types of communication failures at the mobile device.

For example, the interference mitigation action may include temporarily caching cellular communications (e.g., specifically uplink or downlink communications) destined for the mobile device, which would have been transmitted to the mobile device over the frequency channel. In this case, the core application may detect communications received at the cell site and destined for the mobile device, intercept these communications, and temporarily store these communications in a cache or data store in association with an identification of the mobile device. The core application may forward these communications or data related to these communications (e.g., in the case of a missed call) either after a predefined period of time (30 milliseconds) or after a message is received from the mobile device indicating that the mobile device has completed reading the RFID tag(s).

As another example, the interference mitigation action may include rerouting communications destined for the mobile device over another frequency channel (as opposed to the same frequency channel used for the RFID communication). In this case, the core application may reconfigure the cell site (e.g., modify the stored cellular configurations of the cell site) to temporarily forward cellular communications over another frequency channel (e.g., 600 MHz frequency channel) as opposed to the frequency channel being used for the RFID communication (e.g., 800 MHz frequency channel). The core application may wait a predefined period of time (30 milliseconds), and then again reconfigure the cell site to reset to the original cellular communications configurations, to forward cellular communications to the mobile device over the original frequency channel (e.g., 800 MHz). Alternatively, the core application may wait until a message is received from the mobile device indicating that the mobile device has completed reading the RFID tag before resetting the original cellular communications configurations.

As another example, the interference mitigation action may include transmitting an instruction to the application at the mobile device. The instruction may be for the application to present a prompt or notification on a display of the mobile device, in which the prompt or notification indicates a current incoming call and details related to the incoming call to the mobile device. The display may also include one or more icons the user may select to either accept the incoming call and terminate the RFID communication or ignore the incoming call and continue with the RFID communication.

In some cases, the user may be presented with a recommendation as to whether or not to perform RFID communications over the cellular frequency channel when a signal strength to a cell site is less than a threshold value. For example, the user may be entering a location in a rural city, in which the nearest cell site is several miles away, such that the signal strength of the mobile device is weak. In this case, the application at the mobile device may determine a value representing the signal strength of the mobile device based on the strength of the connection to the nearest cell site, and then compare the signal strength to a predefined threshold value. The application may then present a recommendation or suggestion to the user (e.g., as a prompt or notification on a display of the mobile device) based on the comparison. For example, when the signal strength is greater than or equal to the threshold value, the recommendation may indicate that the mobile device is capable of performing RFID communications over the predefined frequency channel without interference. However, when the signal strength is less than the threshold value, the recommendation may indicate that the mobile device should not or is not capable of performing RFID communications over the predefined frequency channel. The user may determine whether or not to read RFID tags based on the notification presented to the user.

Therefore, the embodiments disclosed herein introduce a mechanism by which cellular communications may be modified or tuned based on whether the mobile device is performing RFID communications over the same frequency channel. The application at the mobile device may communicate with a core application at a core network to ensure that any interference between RFID communications and cellular communications over the same frequency channel can be mitigated or eliminated at least for a period of time. Therefore, the embodiments disclosed herein reduce communication interference, thereby reducing connection failures and increasing network capacity.

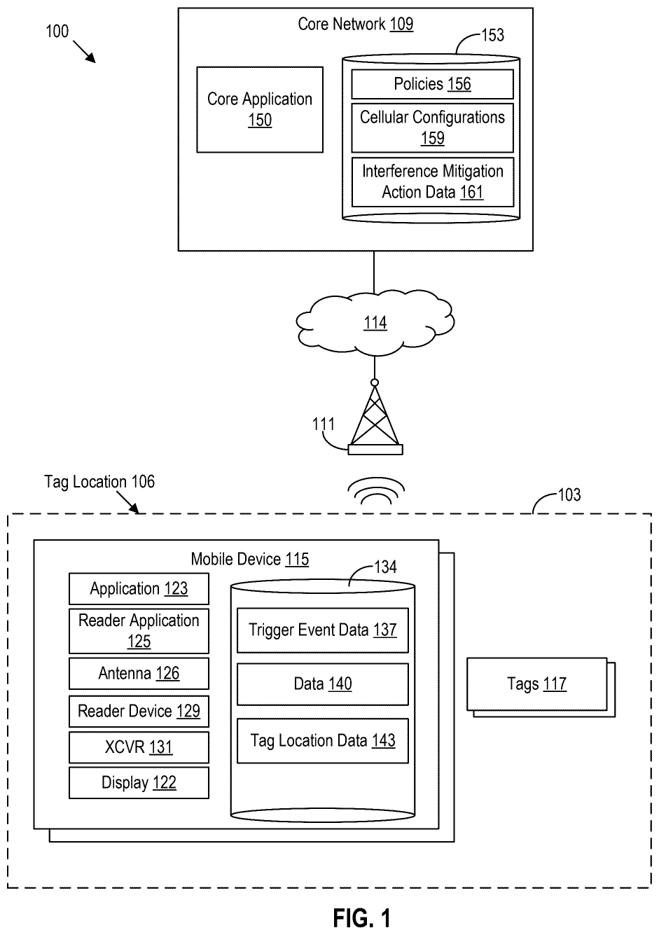

Turning now to FIG. 1, a communication network 100 is described. The communication network 100 includes a system 103 positioned at a tag location 106, a core network system 109, a cell site 111, and a network 114. The tag location 106 may refer to a geographic location area or physical structure (e.g., a building, retail store, or warehouse), which may include or contain the components of the system 103. The system 103 includes one or more mobile devices 115 (e.g., moving within the tag location 106) and one or more tags 117 (e.g., positioned on items available for purchase within the tag location 106). The cell site 111 may provide a wireless communication link to the mobile devices 115 according to a 5G, a long term evolution (LTE), a code division multiple access (CDMA), or a global system for mobile communications (GSM) wireless telecommunication protocol. The network 114 may be one or more private networks, one or more public networks, or a combination thereof. While the system 103 is shown as separate from the network 114, in some embodiments, the system 103 may be part of the network 114.

The tags 117 may refer to RFID tags or other types of tags that contain, for example, a microchip and an antenna, which store and transmit data when activated with radio frequency signals. For example, tags 117 may be attached to items or assets for identification, tracking, and data collection purposes.

The mobile device 115 may be at least temporarily positioned in or around the tag location 106. The mobile device 115 may be any type of user equipment (UE) or device used by an end-user to communicate with a network 114 and core network system 109, encompassing all hardware and software needed for connectivity. Examples of mobile devices 115 include, for example, cellular phones, smartphones, tablets, laptops, headset computers, wearable computers, Internet of Things (IoT) devices, and connected cars.

Each mobile device 115 may include an application 123, a reader application 125, one or more antennas 126, a reader device 129, a radio transceiver 131, a display 122, and a data store 134 (e.g., memory). In some cases, the mobile device 115 may include the hardware and software used for near-field communication (NFC). NFC may be a subset of RFID technology operating at a frequency band shared with some RFID tags (e.g., high frequency RFID tags).

The application 123 and reader application 125 may each include instructions stored on a memory of the mobile device 115, and executable by a processor of the mobile device 115, to perform the steps and operations described herein. For example, the application 123, when executed by the processor of the mobile device 115, may detect trigger events and communicate with the core network system 109 to modify a cellular connection or cellular communications destined for the mobile device 115 for a period of time. The reader application 125, when executed by the processor of the mobile device 115, may initiate reading of a tag 117 and store data obtained from the tag 117.

As mentioned above, the mobile device 115 may include one or more antennas 126, each of which may include one or more antenna elements (e.g., dipoles) used to transmit and receive radio frequency signals over cellular frequency bands. For example, an antenna 126 may capture incoming radio frequency signals from the cell site 111 and tags 117 and radiate outgoing radio frequency signals to communicate with the cell site 111 and the tags 117. The antennas 126 may be any type of antenna, such as, for example, an omnidirectional antenna or a directional antenna. The antennas 126 may have different shapes and sizes and include one or more different elements based on the specific functionality of the antenna 126. The antennas 126 may include various beamforming mechanisms to adjust the amplitude and phases of signals from different antenna elements to emit the signals as directional beams. The antenna 126 may be integrated into the structure of the mobile device 115, and coupled to a radio transceiver 131.

The radio transceiver 131 may modulate outgoing signals for transmission and demodulate incoming signals for processing by the mobile device 115. For example, the radio transceiver may convert electrical signals into radio frequency signals for transmission by the antenna 126, receive radio frequency signals from the antenna 126 and convert these signals into electrical signals for processing by the mobile device 115. In this way, the radio transceiver 131 and the antenna 126 may operate together to perform cellular communications with the cell site 111 and RFID communications with the tags 117 over the same frequency bands.

In some embodiments, the mobile device 115 may also include a reader device 129, which may work with the radio transceiver 131 to (transmit and/or) receive data 140 from the tags 117. The reader device 129 may be part of the mobile device 115 (e.g., the mobile device 115 may include the hardware and software of the reader device 129). The reader device 129 may alternatively be a separate device that is detachably attachable to the mobile device 115 or may be communicatively coupled to the mobile device 115 (e.g., via a BLUETOOTH connection). The reader device 129 may be used to communicate with the tags 117 over the cellular frequency bands (e.g., low frequency bands at 600 MHz, 700 MHz, or 800 MHz, mid-frequency bands at 1.8 GHz or 2.1 GHz, or high frequency bands at 3.5 GHz, 5GHz, or 47 GHz) or the RFID frequency bands (e.g., between 125 kHz to 134 kHz, high frequency bands at 13.56 MHz, ultra-high frequency bands between 860 MHz to 960 MHz, and microwave frequency bands at 2.4 GHz and above).

The data store 134 may store various types of data used by the system 103. As shown in FIG. 1, the data store 134 may store trigger event data 137, data 140, and tag location data 143. The trigger event data 137 may include data describing one or more trigger events, which may occur when the mobile device 115 is about to initiate RFID communications with one or more tags 117. For example, the trigger event data 137 may include a timestamp, an identification of the tag location 106, the action performed by the user or mobile device 115, etc. The data 140 may refer to the data obtained from reading the tag 117. The tag location data 143 may describe the tag locations 106 in which the mobile device 115 has currently or previously read tags 117.

The user of the mobile device 115 may be a subscriber of a telecommunications service providing company. The telecommunications service providing company may provide cellular services (e.g., voice calls, messaging, file transfers, internet connectivity, location tracking, and other services) through the core network system 109 and the cell site 111. The core network system 109 may include the elements that manage the subscriber information, call setup and routing, and related system supports. In an embodiment, the core network system 109 may be an evolved packet core (EPC) core network. The core network system 109 may be configured to implement a 5G, a LTE, a CDMA, or a GSM wireless telecommunication protocol. In one embodiment, the core network system 109 may be a 3rd Generation Partnership Project (3GPP) Evolved Packet System (EPS).

The core network system 109 may include a core application 150 and one or more data stores 153. The core application 150 may manage the connections between the mobile devices 115 and the cell site 111/core network system 109 to control communications within the communication network 100. For example, the core application 150 may be a function of an existing component of the core network system 109 (e.g., the mobility management entity (MME) and/or the access and mobility management function (AMF)). Alternatively, the core application 150 may be a separate, standalone component of the core network system 109.

The data store 153 may store subscription information related to the user (e.g., identification information, subscription plans, purchased devices, billing information, etc.). The data store 153 may also store policies 156, cellular configurations 159, and interference mitigation action data 161. The cellular configurations 159 may include the configurations determined by the core network system 109 as being optimal settings/configurations for cellular communications between the cell site 111 and a mobile device 115 (e.g., a particular frequency band or channel to use to communicate with the mobile device 115). The cellular configurations 159 may be determined based on several factors, such as, for example, a current network configuration, available spectrums, signal qualities, and capabilities of the mobile device 115 (e.g., stored at the core network system 109). The interference mitigation action data 161 may include data associated with the interference mitigation action determined by the core application 150 to be taken on behalf of the cellular communications between the cell site 111 and the mobile device 115 (e.g., the actual interference mitigation action, a time of performing/instructing the interference mitigation action, the involved frequency channels, etc.). Over time, interference mitigation action data 161 collects a history of interference mitigation actions performed by the core application 150, which may be used to train a machine learning model to predict future interference mitigation actions.

The interference mitigation action data 161 may include temporarily caching cellular communications (e.g., specifically uplink or downlink communications) destined for the mobile device 115 over the frequency channel indicated in the cellular configurations 159, rerouting communications destined for the mobile device 115 over another frequency channel, transmitting an instruction to the mobile device 115 indicating that an incoming call is being received for the mobile device 115, temporarily instructing the mobile device 115 to transition into an idle mode for cellular communications over the frequency channel, and/or any other action that involves modifying or tuning a cellular connection between the cell site 111 and the mobile device 115.

The policies 156 may describe one or more rules indicating mappings or associations between trigger event data 137 received from a mobile device 115, a current cellular configuration 159 by the cell site 111 for the mobile device 115, and an interference mitigation action to instruct for the mobile device 115. For example, a policy 156 may indicate that when received trigger event data 137 indicates that the mobile device 115 is attempting to initiate RFID communications with a tag 117 over the same frequency channel that the cell site 111 is used to communicate with the mobile device 115, the core application 150 may identify a particular interference mitigation action to perform to prevent interference between cellular communications and RFID communications over the same frequency channel.

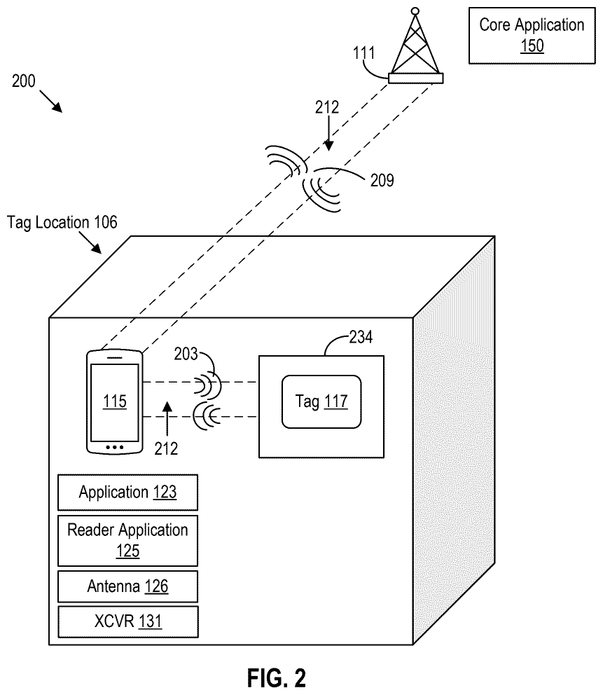

Referring now to FIG. 2, shown is a diagram 200 illustrating a mobile device 115 performing multiple types of communications over the same frequency channel 212. In the example shown in FIG. 2, the mobile device 115 is positioned in or around a tag location 106, which also includes one or more tags 117. Each tag 117 may be coupled to one or more items 234, and the tag 117 may include and transmit data 140 identifying the item 234. The mobile device 115 may be moving in and out of the tag location 106 and/or moving within the tag location 106 at various points in time. In general, the mobile device 115 may be served by the cell site 111 because the tag location 106 is in a coverage area of the cell site 111.

The cellular configurations 159 of the cell site 111 may be set such that the cell site 111 communicates with the mobile device 115 over the frequency channel 212 (and this configuration may be based on the capabilities of the mobile device 115, available bandwidth over other frequency channels, distance between the mobile device 115 and the cell site 111, etc.). Therefore, the mobile device 115 performs cellular communications 209 (e.g., voice calls, messages, data access, etc.) over a predefined frequency channel 212 (e.g., 800 MHz).

Meanwhile, the antenna 126 and radio transceiver 131 may be pre-configured to use the same frequency channel 212 for RFID communications 203. For example, when the user opens the reader application 125 to initiate reading a tag 117 (e.g., and then selects an icon on a user interface presented on the display 122), the antenna 126 may be configured to transmit RFID communications 203 (e.g., radio frequency signals) over the predefined frequency channel 212, and the data 140 may be received back from the tag 117 over the predefined frequency channel 212.

As further described herein, the application 123 may detect a trigger event (e.g., when the user opens the reader application 125 to initiate reading a tag 117 and/or selects the icon) and transmit trigger event data 137 describing the trigger event to the core application 150. The core application 150 may identify an interference mitigation action to perform on behalf of the mobile device 115 based on a policy 156.

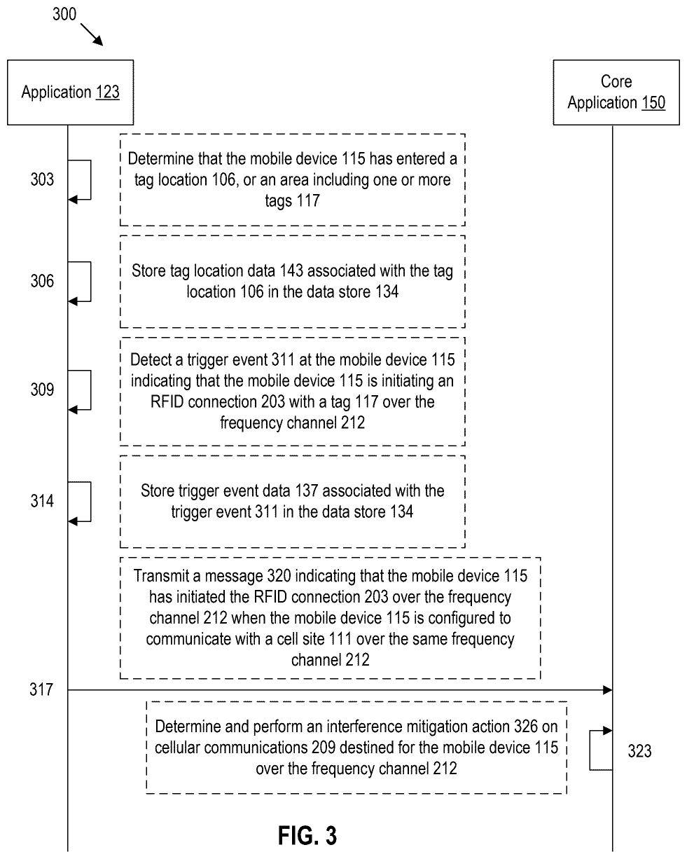

Referring now to FIG. 3, shown is a message sequence diagram illustrating a method 300 for modifying cellular communications 209 between a mobile device 115 and a cell site 111 to accommodate RFID communications 203. Method 300 may be performed by the application 123 of the mobile device 115 and the core application 150 of the core network system 109. In method 300, the mobile device 115 and cell site 111 may be the same as those described above with reference to FIG. 2, in which the mobile device 115 is configured to perform RFID communications 203 with tags 117 and cellular communications 209 with the cell site 111 over the same frequency channel 212.

Method 300 may begin with operation 303. At operation 303, the application 123 may determine that the mobile device 115 has entered a tag location 106, or an area (open or enclosed) including one or more tags 117. Each tag 117 may be coupled to an item 234 and may be used for identification or other purposes.

At operation 306, the application 123 may store tag location data 143 associated with the tag location 106 in the data store 134. The tag location data 143 may include geographic data (e.g., coordinate ranges) identifying the location, a name or entity associated with the tag location 106, types of items 234 included in the tag location 106, a quantity of tags 117 in the tag location 106, the purpose of the tags 117 included in the tag location 106, etc.

At operation 309, the application 123 may detect a trigger event 311 occurring at the mobile device 115. The trigger event 311 may be an event (action) taken at the mobile device 115 indicating that the user is initiating an RFID communication 203 with a tag 117 over the frequency channel 212. In an embodiment, the trigger event 311 may occur when the user opens a reader application 125 at the mobile device 115 or when the user selects an icon or button triggering the mobile device 115 to begin RFID communications 203 and read a tag 117.

For example, the reader application 125 may present on the display 122 one or more icons, selectable by the user to initiate sending radio frequency signals over the frequency channel 212 in a particular direction. The reader application 125 may also present on the display 122 instructions for the user to follow to perform RFID communications 203 with a tag 117. For example, the reader application 125 may present instructions on the display 122 instructing the user to positioned a side of the mobile device 115 (e.g., the side with the antenna 126) a predefined distance range away from the tag 117, and then select the icon to trigger the radio transceiver 131 and antenna 126 to emit interrogation signals (e.g., radio frequency signals) over the frequency channel 212 to power the tag 117, which then triggers the antenna 126 and/or the reader device 129 to receive the data 140 from the tag 117 in response to the interrogation signals.

At operation 314, the application 123 may generate and store trigger event data 137 associated with the trigger event 311 in the data store 134. The trigger event data 137 may describe the actual action or task of the trigger event 311 (e.g., opening of the reader application 125, selection of the icon, moving of the device to a distance from the tag 117, etc.). The trigger event data 137 may also include a timestamp indicating the time of sending the interrogation signal and the time of receiving the response with the data 140 from the tag 117. The trigger event data 137 may also include the tag location data 143 indicating a location in which the trigger event 311 occurred.

At operation 317, the application 123 may generate and transmit a message 320 to the core application 150. The message 320 may indicate that the mobile device 115 has initiated an RFID communication 203 over the frequency channel 212 when the mobile device 115 is configured to communicate with the cell site 111 over the same frequency channel 212 (as indicated in the cellular configurations 159). In an embodiment, the message 320 may include a source identifier identifying the mobile device 115, the trigger event data 137, an indication that the mobile device 115 is intending to perform RFID communications 203 in a future time period (e.g., within the next one minute), and an identification of the frequency channel 212 over which the mobile device 115 is configured to perform RFID communications 203. The core application 150 may use the information in the message 320 to determine whether frequency channel 212 over which the mobile device 115 is to perform RFID communications 203 is the same as the frequency channel 212 indicated in the cellular configurations 159 for the cellular communications 209 between the cell site 111 and mobile device 115.

When the core application 150 determines that the frequency channel 212 used for cellular communications 209 (e.g., as indicated in the cellular configurations 159 stored at the data store 153) matches the frequency channel 212 identified in the message 230, at operation 323, the core application 150 may determine and perform an interference mitigation action 326 on the cellular communications 209 destined for the mobile device 115 over the frequency channel 212. The core application 150 may determine interference mitigation action 326 based on a policy 156. The policy 156 may associate the trigger event data 137 received in the message 320, the identified common frequency channel 212 between both RFID communications 203 and cellular communications 209, and/or any other information related to the mobile device 115 with a particular interference mitigation action 326. For example, a policy 156 may indicate that when received trigger event data 137 indicates that the mobile device 115 is attempting to initiate RFID communications 203 over the same frequency channel 212 as cellular communications 209, the core application 150 may identify a particular interference mitigation action 326 to perform to prevent interference between cellular communications 209 and RFID communications 203 over the same frequency channel 212. For example, the interference mitigation action 326 may include temporarily caching cellular communications 209 (e.g., specifically uplink or downlink communications) destined for the mobile device 115 over the frequency channel 212, rerouting communications destined for the mobile device 115 over another frequency channel, transmitting an instruction to the mobile device 115 indicating that an incoming call is being received for the mobile device 115, and/or any other action that involves modifying or tuning a cellular connection between the cell site 111 and the mobile device 115 over the frequency channel 212.

The core application 150 may perform the interference mitigation action 326 in a variety of different manners. For example, the core application 150 may modify the cellular configurations 159 of the cell site 111 (particularly the cellular configurations 159 for the cellular communications 209 between the cell site 111 and the mobile device 115 based on the identifier of the mobile device 115). The modified cellular configurations 159 may instruct the cell site 111 to temporarily cache all cellular communications 209 destined for the mobile device 115, reroute cellular communications 209 to be sent to the mobile device 115 over a different frequency channel, instruct the mobile device 115 to notify the user of an incoming call that may disrupt the RFID communication 203, etc. The modified cellular configurations 159 may be based on the determined interference mitigation action 326.

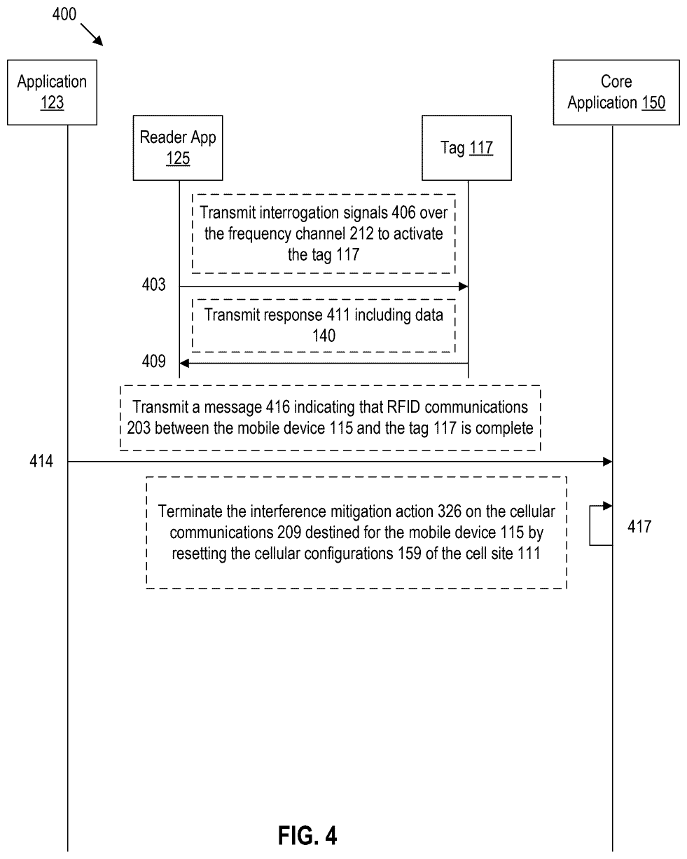

Referring now to FIG. 4, shown is a message sequence diagram illustrating a method 400 for modifying cellular communications 209 between a mobile device 115 and a cell site 111 to accommodate RFID communications 203. Method 400 may be performed by the application 123 and reader application 125 of the mobile device 115, one or more tags 117, and the core application 150 of the core network system 109. In method 400, the mobile device 115 and cell site 111 may be the same as those described above with reference to FIG. 2, in which the mobile device 115 is configured to perform RFID communications 203 with tags 117 and cellular communications 209 with the cell site 111 over the same frequency channel 212. In an embodiment, method 400 may be performed after operation 323 of method 300 has been performed, such that the core application 150 may be currently implementing an interference mitigation action 326 on the cellular communications 209 to reduce or eliminate interference between the cellular communications 209 and the RFID communications 203.

At operation 403, the reader application 125 may instruct the radio transceiver 131 and the antenna 126 to generate and transmit interrogation signals 406 (e.g., radio frequency signals over the frequency channel 212) in a particular direction to activate the tag 117. The tag 117 may be powered up using the signals received over the frequency channel 212, and the tag 117 may use the power to transmit back a response 411 with data 140 to the reader application 125. The data 140 may include, for example, identification information of the item 234 coupled to the tag 117. After the reader application 125 receives the response 411 from the tag 117, at operation 414, the application 123 may transmit a message 416 to the core application 150. The message 416 may indicate that the RFID communications 203 between the mobile device 115 and the tag 117 is complete (e.g., the reader application 125 has received the response 411 from the tag 117).

At operation 417, the core application 150 may terminate performance of the interference mitigation action 326 on the cellular communications 209 destined for the mobile device 115. For example, the core application 150 may reset the cellular configurations 159 of the cell site 111 such that the cell site 111 resumes communicating with the mobile device 115 over the original frequency channel 212. This in turns resets the cellular configurations 159 for cellular communications 209 between the cell site 111 and the mobile device 115 to how the cellular configurations 159 were prior to performing the interference mitigation action 326.

Therefore, in method 400, the cellular communications 209 for the mobile device 115 are reset only after the core application 150 receives a message 416 indicating that RFID communications 203 for the mobile device 115 is complete. In another embodiment, the core application 150 may be configured to perform the interference mitigation action 326 for a predefined period of time (e.g., 30 ms), and then operation 417 may be performed to terminate the interference mitigation action 326 and reset the cellular communications 209 for the mobile device 115. In this embodiment, the cellular communications 209 for the mobile device 115 are reset based on the predefined period of time (i.e., the message 416 may not have to be received before operation 417 is performed to terminate the interference mitigation action 326).

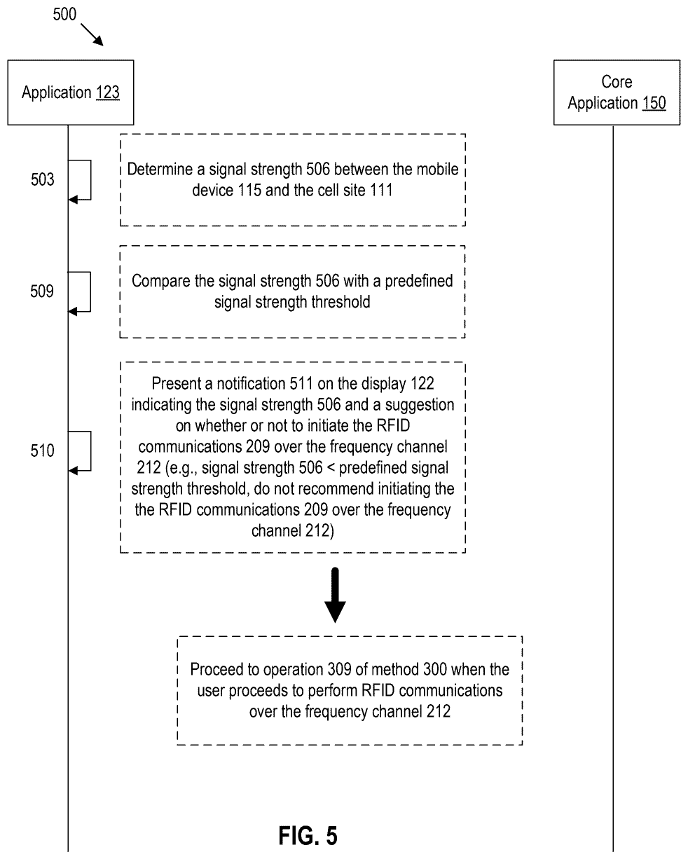

Referring now to FIG. 5, shown is a message sequence diagram illustrating a method 500 for modifying cellular communications 209 between a mobile device 115 and a cell site 111 to accommodate RFID communications 203. Method 500 may be performed by the application 123 of the mobile device 115. In method 500, the mobile device 115 and cell site 111 may be the same as those described above with reference to FIG. 2, in which the mobile device 115 is configured to perform RFID communications 203 with tags 117 and cellular communications 209 with the cell site 111 over the same frequency channel 212. In an embodiment, method 500 may be performed before the mobile device 115 initiates the RFID communication 203 with the tag 117 and after operation 306 of method 300 is performed.

At operation 503, the application 123 may determine a signal strength 506 between the mobile device 115 and the cell site 111. For example, the signal strength 506 may be a value (e.g., between 0-1) corresponding to a power level received by the mobile device 115 from the cell site 111, indicating a quality and reliability of the cellular connection between the mobile device 115 and the cell site 111.

After determining the signal strength 506, at operation 509, the application 123 may compare the signal strength 506 with a predefined signal strength threshold. The comparison may be used to determine a suggestion on whether the mobile device 115 should or should not to initiate the RFID communications 203 over the frequency channel 212. At operation 510, the application 123 may present a notification 511 on the display 122 of the mobile device 115 based on the comparison. The notification 511 may indicate the signal strength 506 and the suggestion on whether the mobile device 115 should or should not to initiate the RFID communications 203 over the frequency channel 212.

For example, when the signal strength 506 is lower than the predefined signal strength threshold, the application 123 may suggest that the mobile device 115 should not use the frequency channel 212 for RFID communications 203. This determination may be based on the signal strength 506 to the cell site 111 (across all frequency bands) being lower than the predefined signal strength threshold, such that the user will lose all connectivity if the mobile device 115 is used for RFID communications 203 using any cellular frequency bands.

After operation 510 and when the user decides to proceed with performing RFID communications 203 (regardless of the suggestion in the notification 511), method 500 may proceed to operation 309 of method 300. Therefore, the notification 511 may be used to present the user with information about how RFID communications 203 may affect a cellular connection of the mobile device 115 before the user initiates the RFID communications 203.

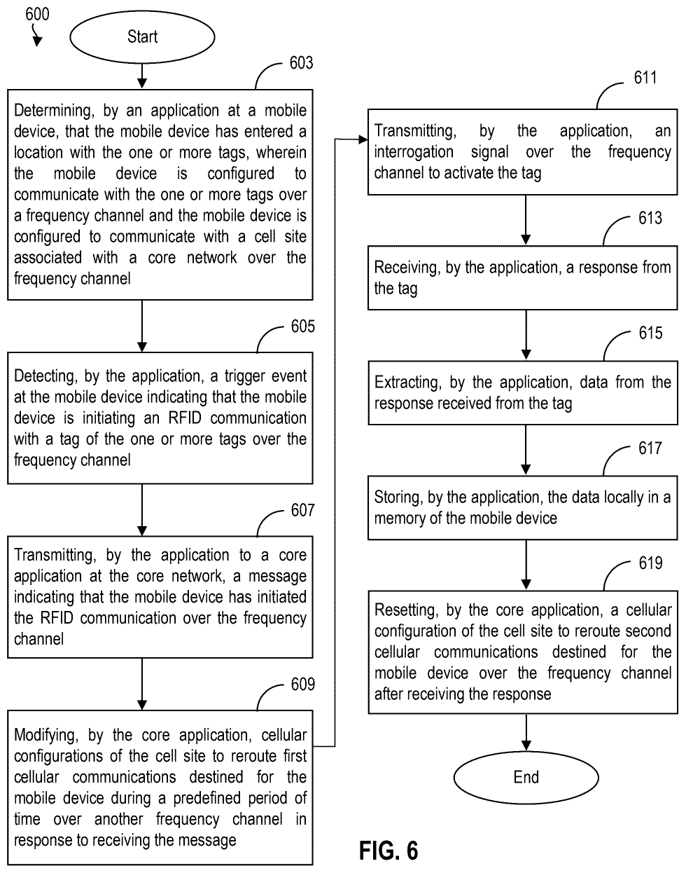

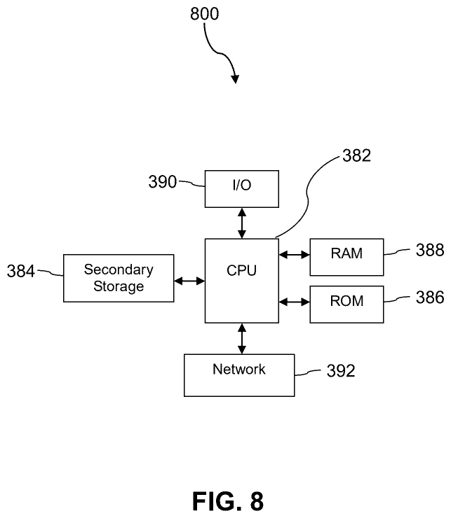

Referring now to FIG. 6, shown is a method 600 for modifying a cellular connection with a cell site 111 to accommodate an RFID connection with one or more tags 117. Method 600 may be performed by the application 123 of the mobile device 115 and the core application 150 of the core network system 109. In method 600, the mobile device 115 and cell site 111 may be the same as those described above with reference to FIG. 2, in which the mobile device 115 is configured to perform RFID communications 203 with tags 117 and cellular communications 209 with the cell site 111 over the same frequency channel 212. In embodiments, the method 600 may be implemented using a computer system with components as shown in FIG. 8. As illustrated, method 600 of FIG. 6 includes a number of enumerated operations, but embodiments of the operations in FIG. 6 may include additional operations before, after, and in between the enumerated operations. In some embodiments, one or more of the enumerated operations may be omitted or performed in a different order.

At step 603, method 600 may include determining, by an application 123 at a mobile device 115, that the mobile device 115 has entered a location (e.g., tag location 106) with one or more tags 117. The mobile device 115 is configured to communicate with the one or more tags 117 over the frequency channel 212 and the mobile device 115 is configured to communicate with a cell site 111 associated with a core network over the frequency channel 212. At step 605, method 600 may include detecting, by the application 123, a trigger event 311 at the mobile device 115. The trigger event 311 indicates that the mobile device 115 is initiating an RFID communication 203 with a tag 117 of the one or more tags 117 over the frequency channel 212.

At step 607, method 600 may include transmitting, by the application 123 to a core application 150 at the core network system 109, a message 320 indicating that the mobile device 115 has initiated the RFID communication 203 over the frequency channel 212. At step 609, method 600 may include modifying, by the core application 123, cellular configurations 159 of the cell site 111 to reroute first cellular communications 209 destined for the mobile device 115 during a predefined period of time over another frequency channel in response to receiving the message 320.

At step 611, method 600 may include transmitting, by the application 123, an interrogation signal 406 over the frequency channel 212 to activate the tag 117. At step 613, method 600 may include receiving, by the application 123, a response 411 from the tag 117. At step 615, method 600 may include extracting, by the application 123, data 140 from the response 411 received from the tag 117. At step 617, method 600 may include storing, by the application 123, the data 140 locally in a memory (e.g., data store 134) of the mobile device 115. At step 619, method 600 may include resetting, by the core application 123, a cellular configuration 159 of the cell site 111 to reroute second cellular communications 209 destined for the mobile device 115 over the frequency channel 212 after receiving the response 411.

Method 600 may further comprise additional attributes and/or steps not explicitly shown in FIG. 6. In an embodiment, wherein the trigger event 311 comprises at least one of opening a reader application 125 at the mobile device 115, aiming the mobile device 115 to the tag 117, or selecting an icon on a user interface displayed at the mobile device 115. In an embodiment, the frequency channel 212 is an 800 MHz frequency channel.

In an embodiment, method 600 may further include transmitting, by the application 123 to the core application 150, a second message 416 indicating that the RFID communication 203 at the mobile device 115 is complete, triggering the core application 150 to perform the resetting of the cellular configurations 159 of the cell site 111. In an embodiment, method 600 may further comprise transmitting, by the application 123 to the core application 150, a notification indicating that the mobile device 115 is entering the location with the one or more tags 117, and monitoring, by the core application 150, actions of the mobile device 115 within the location in response to receiving the notification.

In an embodiment, after resetting of the cellular configurations 159 of the cell site 111, method 600 may further include performing, by the application 123, a task using the data obtained from the tag 117. In an embodiment, method 600 may further include presenting, by the application 123 on a display 122 of a mobile device 115, a notification 511 indicating a signal strength 506 between the mobile device 115 and the cell site 111 and whether to initiate the RFID communication 203.

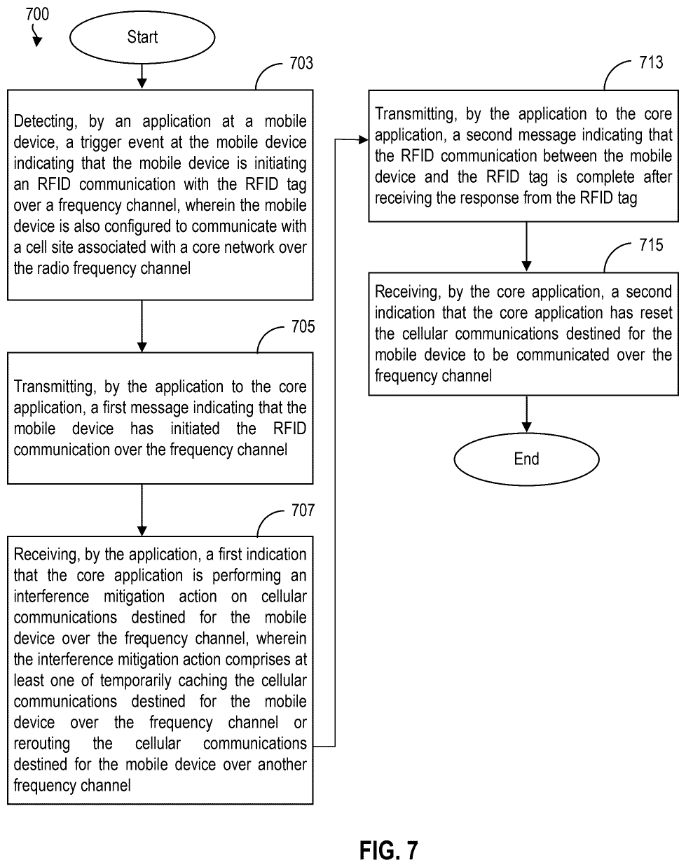

Referring now to FIG. 7, shown is a method 700 for modifying a cellular connection with a cell site 111 to accommodate an RFID connection with a tag 117 (referred to as an “RFID tag 117” in this description of FIG. 7). Method 700 may be performed by the application 123 of the mobile device 115. In method 700, the mobile device 115 and cell site 111 may be the same as those described above with reference to FIG. 2, in which the mobile device 115 is configured to perform RFID communications 203 with tags 117 and cellular communications 209 with the cell site 111 over the same frequency channel 212. In embodiments, the method 700 may be implemented using a computer system with components as shown in FIG. 8. As illustrated, method 700 of FIG. 7 includes a number of enumerated operations, but embodiments of the operations in FIG. 7 may include additional operations before, after, and in between the enumerated operations. In some embodiments, one or more of the enumerated operations may be omitted or performed in a different order.

At step 703, method 700 may include detecting, by an application 123 at a mobile device 115, a trigger event 311 at the mobile device 115. The trigger event 311 indicates that the mobile device 115 is initiating an RFID communication 203 with the RFID tag 117 over a frequency channel 212. The mobile device 115 is also configured to communicate with a cell site 111 associated with a core network system 109 over the frequency channel 212.

At step 705, method 600 may include transmitting, by the application 123 to a core application 150 at the core network system 109, a first message 320 indicating that the mobile device 115 has initiated the RFID communication 203 over the frequency channel 212. At step 707, method 600 may include receiving, by the application, a first indication that the core application 150 is performing an interference mitigation action 326 on cellular communications 209 destined for the mobile device 115 over the frequency channel 212. The first indication may be a message or notification indicating that the core network system 109 is performing the interference mitigation action 326 on cellular communications 209 destined for the mobile device 115 to reduce or eliminate interference during the RFID communication 203. The interference mitigation action 326 comprises at least one of temporarily caching the cellular communications 209 destined for the mobile device 115 over the frequency channel 212 or rerouting the cellular communications 209 destined for the mobile device 115 over another frequency channel.

At this point, method 700 may comprise transmitting, by the application 123, an interrogation signal 406 over the frequency channel 212 to activate the RFID tag 117 in response to receiving the first indication, and receiving, by the application 123, a response 411 from the RFID tag 117. At step 713, method 700 may include transmitting, by the application 123 to the core application 150, a second message 416 indicating that the RFID communication 203 between the mobile device 115 and the RFID tag 117 is complete after receiving the response 411 from the RFID tag 117. At step 715, method 700 may include receiving, by the core application 123, a second indication that the core application 150 has reset the cellular communications 209 destined for the mobile device 115 to be communicated over the frequency channel 212 (e.g., by resetting the cellular configurations 519 of the cell site 111).

Method 700 may further comprise additional attributes and/or steps not explicitly shown in FIG. 7. In an embodiment, method 700 may further include determining, by the application 123, that the mobile device 115 has entered a location (e.g., tag location 106) with the RFID tag 117, and transmitting, by the application 123 to the core application 150, a notification indicating that the mobile device 115 is entering the location with the RFID tag 117. In an embodiment, wherein the trigger event 311 comprises at least one of opening a reader application 125 at the mobile device 115, aiming the mobile device 115 to the tag 117, or selecting an icon on a user interface displayed at the mobile device 115. In an embodiment, the frequency channel 212 is an 800 MHz frequency channel.

In an embodiment, after transmitting the second message 416, method 600 may further comprise extracting, by the application 123, data 140 from the response 411 received from the RFID tag 117, storing, by the application 123, the data 140 locally in a memory (e.g., data store 134) of the mobile device 115, and performing, by the application 123, a task using the data 140. In an embodiment, the task is associated with at least one of inventory tracking, inventory management, item purchasing, user identification and authorization, or access control. In an embodiment, wherein before the RFID communication 203 is initiated at the mobile device 115, method 700 may further comprise presenting, by the application 123 on a display 122 of a mobile device 115, a second notification indicating that a signal strength 506 between the mobile device 115 and the cell site 111 exceeds a threshold for initiating the RFID communication 203 over the frequency channel 212.

FIG. 8 illustrates a computer system 800 suitable for implementing one or more embodiments disclosed herein. In an embodiment, the mobile device 115 be implemented as the computer system 800. The computer system 800 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 800, at least one of the CPU 382, the RAM 388, and the ROM 386 are changed, transforming the computer system 800 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 800 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 800 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 800 to provide the functionality of a number of servers that is not directly bound to the number of computers in the computer system 800. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 800, at least portions of the contents of the computer program product to the secondary storage 384, to the ROM 386, to the RAM 388, and/or to other non-volatile memory and volatile memory of the computer system 800. The processor 382 may process the executable instructions and/or data structures in part by directly accessing the computer program product, for example by reading from a CD-ROM disk inserted into a disk drive peripheral of the computer system 800. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 800.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 800 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for modifying a cellular connection with a cell site to accommodate a radio frequency identification (RFID) connection with one or more tags, the method comprising:
determining, by an application at a mobile device, that the mobile device has entered a location with the one or more tags, wherein the mobile device is configured to communicate with the one or more tags over a frequency channel and the mobile device is configured to communicate with a cell site associated with a core network over the frequency channel;
detecting, by the application, a trigger event at the mobile device indicating that the mobile device is initiating an RFID communication with a tag of the one or more tags over the frequency channel;
transmitting, by the application to a core application at the core network, a message indicating that the mobile device has initiated the RFID communication over the frequency channel;
modifying, by the core application, cellular configurations of the cell site to reroute first cellular communications destined for the mobile device during a predefined period of time over another frequency channel in response to receiving the message;
transmitting, by the application, an interrogation signal over the frequency channel to activate the tag;
receiving, by the application, a response from the tag;
extracting, by the application, data from the response received from the tag;
storing, by the application, the data locally in a memory of the mobile device; and
resetting, by the core application, a cellular configuration of the cell site to reroute second cellular communications destined for the mobile device over the frequency channel after receiving the response.

2. The method of claim 1, wherein the trigger event comprises at least one of opening a reader application at the mobile device, aiming the mobile device to the tag, or selecting an icon on a user interface displayed at the mobile device.

3. The method of claim 1, wherein the frequency channel is 800 megahertz (MHz).

4. The method of claim 1, further comprising transmitting, by the application to the core application, a second message indicating that the RFID communication at the mobile device is complete, triggering the core application to perform the resetting of the cellular configurations of the cell site.

5. The method of claim 1, further comprising:
transmitting, by the application to the core application, a notification indicating that the mobile device is entering the location with the one or more tags; and
monitoring, by the core application, actions of the mobile device within the location in response to receiving the notification.

6. The method of claim 1, wherein after resetting of the cellular configurations of the cell site, the method further comprises performing, by the application, a task using the data obtained from the tag.

7. The method of claim 1, further comprising presenting, by the application on a display of a mobile device, a notification indicating a signal strength between the mobile device and the cell site and whether to initiate the RFID communication.

8. A method, comprising:
detecting, by an application at a mobile device, a trigger event at the mobile device indicating that the mobile device is initiating an RFID communication with the RFID tag over a frequency channel, wherein the mobile device is also configured to communicate with a cell site associated with a core network over the frequency channel;
transmitting, by the application to a core application at a core network system, a first message indicating that the mobile device has initiated the RFID communication over the frequency channel;
receiving, by the application, a first indication that the core application is performing an interference mitigation action on cellular communications destined for the mobile device over the frequency channel, wherein the interference mitigation action comprises at least one of temporarily caching the cellular communications destined for the mobile device over the frequency channel or rerouting the cellular communications destined for the mobile device over another frequency channel;
transmitting, by the application to the core application, a second message indicating that the RFID communication between the mobile device and the RFID tag is complete when a response from the RFID tag; and
receiving, by the core application, a second indication that the core application has reset the cellular communications destined for the mobile device to be communicated over the frequency channel.

9. The method of claim 8, further comprising:
determining, by the application, that the mobile device has entered a location with the RFID tag; and
transmitting, by the application to the core application, a notification indicating that the mobile device is entering the location with the RFID tag.

10. The method of claim 8, wherein the frequency channel is 800 megahertz (MHz).

11. The method of claim 8, wherein the trigger event comprises at least one of opening a reader application at the mobile device, aiming the mobile device to the RFID tag, or selecting an icon on a user interface displayed at the mobile device.

12. The method of claim 8, wherein after transmitting the second message, the method further comprises:
extracting, by the application, data from the response received from the RFID tag;
storing, by the application, the data locally in a memory of the mobile device; and
performing, by the application, a task using the data.

13. The method of claim 12, wherein the task is associated with at least one of inventory tracking, inventory management, item purchasing, user identification and authorization, or access control.

14. The method of claim 8, wherein before the RFID communication is initiated at the mobile device, the method further comprises presenting, by the application on a display of a mobile device, a second notification indicating that a signal strength between the mobile device and the cell site exceeds a threshold for initiating the RFID communication over the frequency channel.

15. A core network system, comprising:
a memory;
a processor; and
a core application comprising instruction stored on the memory, which when executed by the processor, causes the processor to:
receive a first message indicative of a trigger event at a mobile device, wherein the trigger event occurs when the mobile device is initiating an RFID communication with an RFID tag over a frequency channel;
perform an interference mitigation action on a cellular communication destined for the mobile device over the frequency channel;
receive a second message indicating that the RFID communication between the mobile device and the RFID tag is complete;
terminate the interference mitigation action on the cellular communication destined for the mobile device over the frequency channel; and
reset a cellular configuration of the cell site to reroute second cellular communications destined for the mobile device over the frequency channel.

16. The core network system of claim 15, wherein the mobile device is also configured to communicate with a cell site associated with the core network over the frequency channel.

17. The core network system of claim 15, wherein the interference mitigation action comprises temporarily caching the cellular communication destined for the mobile device over the frequency channel or rerouting the cellular communication destined for the mobile device over another frequency channel.

18. The core network system of claim 15, wherein the trigger event comprises at least one of opening a reader application at the mobile device, aiming the mobile device to the RFID tag, or selecting an icon on a user interface displayed at the mobile device.

19. The core network system of claim 15, wherein the core application, when executed by the processor, further causes the processor to:
receive a notification indicating that the mobile device is entering a location with one or more RFID tags; and
monitor actions of the mobile device within the location in response to receiving the notification.

20. The core network system of claim 15, wherein the interference mitigation action further comprises temporarily instructing the mobile device to transition into an idle mode for cellular communications over the frequency channel.
